(19) United States
(12) Patent Application Publication
(10) Pub. No.: US 2023/0298111 A9
(43) Pub. Date: Sep. 21, 2023

(54) Systems and Methods for Improved Transaction Reconciliation

(71) Applicant: Xero Limited, Wellington (NZ)

(72) Inventors: Craig McCormick, Wellington (NZ); Juan Carlos Rada-Vilela, Wellington (NZ); Anastasia Nadine Old, Wellington (NZ); Qiuying Zhang, Wellington (NZ); Stanley Roache, Wellington (NZ); Rodger McNab, Wellington (NZ)

(21) Appl. No.: 17/693,293

(22) Filed: Mar. 11, 2022

Related U.S. Application Data
(63) Continuation of application No. PCT/NZ2021/050141, filed on Aug. 20, 2021.

(30) Foreign Application Priority Data
Dec. 10, 2020 (AU) 2020904606

(51) Int. Cl. G06Q 40/00

(52) U.S. Cl. CPC G06Q 40/128; G06Q 40/125; G06Q 40/123

(57) ABSTRACT

Described embodiments relate to a method comprising determining a financial data item of a financial record to be reconciled, determining a candidate accounting record of a plurality of accounting records, and determining an accounting data item of the candidate accounting record, determining, as a first input to a classification model, a first similarity measure indicative of the similarity of the financial data item to the accounting data item, determining, as a second input to the classification model, a second similarity measure indicative of the similarity of the accounting data item to the financial data item, inputting, to the classification model, the first and second inputs, the classification model configured to determine a probability of the financial data item and the accounting data item corresponding to a common transaction, and outputting an indication of the probability of the financial data item and the accounting data item corresponding to a common transaction.

### TECHNICAL FIELD

Embodiments generally relate to systems, methods and computer-readable media for facilitating improved transaction reconciliation, and in particular, systems methods and computer-readable media that employ a classification based matching engine for matching financial records with accounting records to provide improved reconciliation suggestions and/or automatic reconciliation of transactions.

### BACKGROUND

Reconciliation is a procedure for confirming that the entries in an accounting system match the corresponding entries in a bank statement. When an account holder or accountant receives a bank statement, the accountant has to identify each entry in the bank statement to identify the corresponding account. However, bank statements often include vague entries, which makes it difficult to identify the corresponding account and party. For example, an entry may not include the name of the payer, instead providing a general description of the nature of the entry, such as taxes, drawings, or wages. Sometimes, the name of a party to the transaction may be inferred, such as for an entry “property taxes,” by identifying the local entity where property taxes are paid.

Because of the great degree of variability in bank statement descriptions, bank reconciliation can be a difficult task, more so for a computer program trying to automatically reconcile the data. A person may use their experience to identify the nature of transactions, but automating a computer program to automatically identify the nature of a transaction, as well as the parties of the transaction, is a difficult task due to the lack of standardisation in providing descriptions for bank statements.

Any discussion of documents, acts, materials, devices, articles or the like which has been included in the present specification is not to be taken as an admission that any or all of these matters form part of the prior art base or were common general knowledge in the field relevant to the present disclosure as it existed before the priority date of each of the appended claims.

### SUMMARY

Described embodiments relate to a method comprising: determining a financial data item of a financial record to be reconciled, the financial data item comprising at least one financial data string having one or more financial data characters; determining a candidate accounting record of a plurality of accounting records; determining an accounting data item of the candidate accounting record, the accounting data item comprising at least one accounting data string having one or more accounting data characters; determining, as a first input to a classification model, a first similarity measure indicative of the similarity of the financial data item to the accounting data item; determining, as a second input to the classification model, a second similarity measure indicative of the similarity of the accounting data item to the financial data item; inputting, to the classification model, the first and second inputs, the classification model configured to determine a probability of the financial data item and the accounting data item corresponding to a common transaction; and outputting, from the classification model, an indication of the probability of the financial data item and the accounting data item corresponding to a common transaction.

In some embodiment, the determining the first similarity measure comprises determining a sum of the length of financial data strings of the financial data item that have at least two financial data characters present in the at least one accounting data string of the accounting data item, and wherein determining the second similarity measure comprises determining a sum of the length of accounting data strings of the accounting data item that have at least two accounting data characters present in the at least one financial data string of the financial data item.

In some embodiments, prior to determining a sum of the length of financial data strings of the financial record, the method comprises applying a first weight to number strings of the at least one financial data string and a second weight to alphabet strings of the at least one financial data string. The first weight may be the same as the second weight or may be different from the second weight. Similarly, prior to determining a sum of the length of accounting data strings of the accounting record, the method may comprise applying a third weight to number strings of the at least one financial data string and a fourth weight to alphabet strings of the at least one financial data string. The third weight may be the same as the fourth weight or may be different from the fourth weight.

The method may comprise determining, as a third input to the classification model, an absolute date difference between an accounting date associated with the accounting data item and a financial date associated with the financial data item; and inputting, to the classification model, the third input. The method may comprise determining, as a fourth input to the classification model, a due date associated with the accounting record; and inputting, to the classification model, the fourth input. The method may comprise determining, as a fifth input to the classification model, a number of common data strings between the financial data item and the accounting data item; and inputting, to the classification model, the fifth input. The method may comprise determining, as a sixth input to the classification model, a sum of the length of common data strings between the financial data item and the accounting data item; and inputting, to the classification model, the sixth input.

In some embodiments, the method comprises: before determining the first and second inputs, normalising at least one of the financial data item and the accounting data item, wherein normalising comprises: converting any letters in the financial data string and/or accounting data string to lowercase letters. The method may comprise: before determining the first and second inputs, pre-processing at least one of the financial data item and the accounting data item, wherein pre-processing comprises: determining data strings of the financial data item or accounting data item that comprise alphanumeric words; and for each determined alphanumeric word, modifying the financial data item or accounting data item to include a new data string for each numeral string comprising consecutive numbers of the alphanumeric word and a new data string for each alphabet string comprising consecutive letters of the alphanumeric word. The method may comprise: before determining the first and second inputs, filtering one or more of the financial data string and the accounting data string to remove occurrences of predefined special strings of characters and/or predefined special characters.

In some embodiments, the classification model is a logistic regression model.

In some embodiments, the method comprises: determining a subsequent candidate accounting record of the plurality of accounting records; determining a subsequent accounting data item of the subsequent accounting record, the subsequent accounting data item comprising at least one subsequent accounting data string having one or more subsequent accounting data characters; determining, as a subsequent first input to the classification model, a subsequent first similarity measure indicative of the similarity of the financial data item to the subsequent accounting data item; determining, as a subsequent second input to the classification model, a subsequent second similarity measure indicative of the similarity of the subsequent accounting data item to the financial data item; inputting, to the classification model, the subsequent first and second subsequent inputs, the classification model configured to determine a probability of the financial data item and the subsequent accounting data item corresponding to a common transaction; and outputting, from the classification model, an indication of the probability of the financial data item and the subsequent accounting data item corresponding to a common transaction.

The method may comprise: determining one or more suggestions for reconciling the financial record based on one or more outputs from the classification model. For example, the suggestion may comprise a description of the accounting record, a name of a second entity associated with the accounting record, and an account associated with the accounting record. In some embodiments, determining one or more suggestions comprises: comparing the indication of the probability of the financial data item and the accounting data item of the candidate accounting record with a first threshold and a second threshold; responsive to the indication exceeding the first threshold and the second threshold, automatically reconciling the transaction; responsive to the indication exceeding the first threshold but not exceeding the second threshold, presenting a suggestion for reconciling the transaction to a user via a user interface, and responsive to receiving approval from the user, reconciling the transaction.

Some embodiments relate to a method comprising: determining a financial data item of a financial record to be reconciled, the financial data item comprising at least one financial data string having one or more financial data characters; determining a candidate accounting record of a plurality of accounting records; determining an accounting data item of the candidate accounting record, the accounting data item comprising at least one accounting data string having one or more accounting data characters; determining, as a first input to a classification model, a first similarity measure indicative of the similarity between the financial data item and the accounting data item; inputting, to the classification model, the first input, the classification model configured to determine a probability of the financial data item and the accounting data item corresponding to a common transaction; and outputting, from the classification model, an indication of the probability of the financial data item and the accounting data item corresponding to a common transaction.

Some embodiments relate to a method comprising: identifying a first feature and a second feature for reconciling transactions of a first entity by a classification model, each transaction being associated with a financial data item of a financial record, and with an accounting data item of an accounting record, where the first feature is a first similarity measure indicative of the similarity of the financial data item to a candidate accounting data item, and the second feature is a second similarity measure indicative of the similarity of the candidate accounting data item to the financial data item; training, by one or more processors, the classification model with training data, the training data comprising values for first and second features of an associated financial record and accounting record pair and an outcome indicative of whether the associated financial record and accounting record pair were previously matched as belonging to a common transaction; and providing the trained classification model for reconciling transactions.

In some embodiments, the financial data item comprises at least one financial data string having one or more financial data characters and the accounting data item comprises at least one accounting data string having one or more accounting data character, and wherein the first feature comprises a number of financial data strings having at least two financial data characters present in the at least one accounting data string of the accounting data item and the second feature comprises a number of accounting data strings having at least two accounting data characters present in the at least one financial data string of the financial data item.

Described embodiments relate to a system comprising: one or more processors; and memory comprising computer executable instructions, which when executed by the one or more processors, cause the system to perform any one of the described methods.

Described embodiments relate to a non-transitory machine-readable storage medium including instructions that, when executed by a machine, cause the machine to perform any one of the described methods.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

### BRIEF DESCRIPTION OF DRAWINGS

Various ones of the appended drawings merely illustrate example embodiments of the present disclosure and cannot be considered as limiting its scope.

FIG. 1 is a diagram illustrating the reconciliation of a transaction, according to some example embodiments;

FIG. 2A illustrates the process for using a machine-learning program to reconcile a transaction extracted from a bank statement, according to some example embodiments;

FIG. 2B is a user interface for reconciling transactions, according to some example embodiments;

FIG. 3 is a schematic diagram of a communication system comprising an accounting system configured to reconcile transactions, according to some embodiments;

FIG. 4 is a process flow diagram of a method of reconciling transactions, according to some embodiments;

FIG. 5 is a schematic example of the determination of an indication of a probability of a financial record matching a plurality of candidate accounting records; and

FIG. 6 is a process flow diagram of training a classification model to determine an indication of a probability of a financial record matching a candidate accounting record.

### DESCRIPTION OF EMBODIMENTS

Described embodiments relate to systems, methods and computer-readable media for facilitating improved transaction reconciliation, and in particular, systems methods and computer-readable media that employ a classification based matching engine for matching financial records with accounting records to provide improved reconciliation suggestions and/or automatic reconciliation of transactions.

There are two aspects of bank reconciliation: payments and receivables, that is, expenses and income. For example, when an expense is identified in a financial record, such as a bank statement, the reconciliation process has to categorise that expense to be associated with a certain person or label, such as sales. Also, the reconciliation process identifies the other party to the transaction. The format and particularisation of financial records and/or accounting records can make the reconciliation process technically challenging. Often financial records, such as bank feeds, from or originating at different financial systems, such as bank servers, can take different forms and include different types of information or transaction attributes, and different formats. Additionally, character strings of financial records and/or accounting records can be fragments, truncated, misspelt and/or omitted, further complicating the reconciliation process. Described embodiments use financial data, as for example may be provided in a financial records, such as a bank statement entry or a bank feed, and a matching engine for determining more accurate score or probability values of matches between financial transactions to be reconciled and candidate accounting records.

The matching engine comprises a similarity determination module and a classification module. The similarity determination module is configured to determine text similarity between input values for the classification module from a financial data item of a financial record to be reconciled, and an accounting data item of a candidate accounting record. In some embodiments, the similarity determination module determines both a similarity measure indicative of the similarity of the financial record to the accounting record and a second similarity measure indicative of the similarity of the accounting record to the financial record. As truncation of words and data strings may occur in either or both of the accounting records and the financial records, by taking a bi-directional approach, that is the similarity measure indicative of the similarity of the financial record to the accounting record and a second similarity measure indicative of the similarity of the accounting record to the financial record, an improved and more informative similarity measure is determined.

The classification model may, for example, be a logistic regression model.

In some embodiments, the financial data and/or accounting data is formatted to convert it into a form suitable for providing to the matching engine, thereby providing for improved similarity matching.

The matching engine may further comprise a reconciliation module configured to receive outputs (e.g., scores) from the classification model and generate suggestions for reconciling the financial record, and/or automatically reconcile the financial record with a candidate accounting record based on the scores. This simplifies the work of the reconciling user, such as an accountant, because the user simply has to choose from one or more suggestions for reconciliation, or because the system automatically reconciles some entries without requiring work from the user.

Accounting documents, such as accounting or business records, include any records associated with a particular transaction performed by a business, such as an invoice or receivable record associated with an amount owed to the business by a payee, a bill or payable record associated with money spent by the business, and the like. Financial documents or records, such as banking records may include any records associated with a financial institution, including a record indicating receipt of payment of a particular amount at an account of the financial institution, a record indicating a withdrawal from the account for a particular amount, and the like.

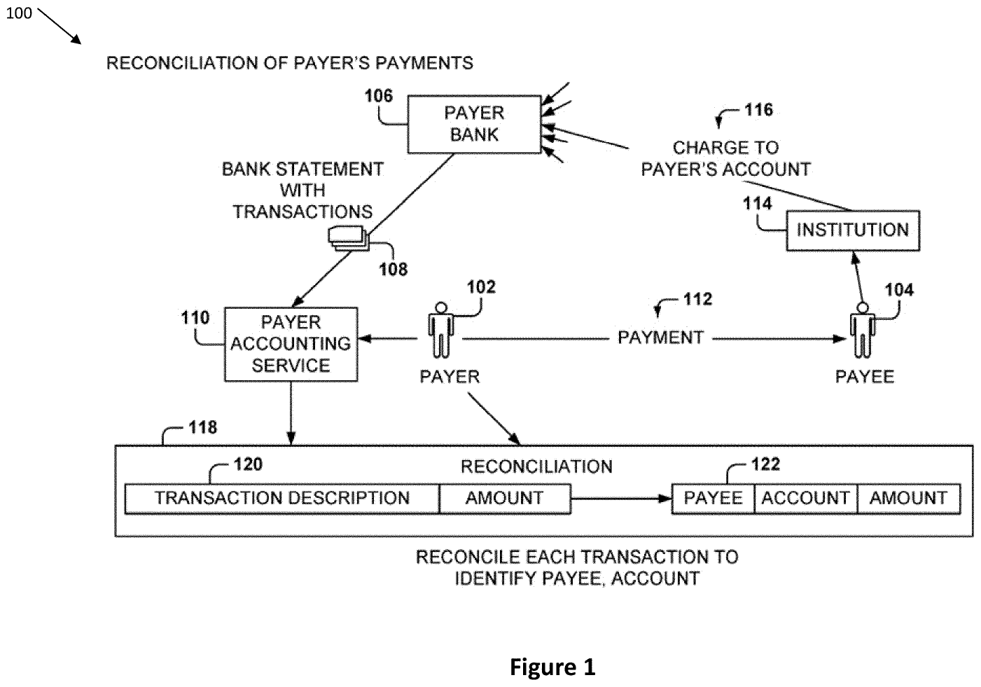

FIG. 1 is a diagram illustrating a process 100 of reconciling transactions, according to some example embodiments. In accounting, reconciliation is the process of ensuring that two sets of records (e.g., the balances of two accounts) are in agreement. For example, reconciliation is used to ensure that the money leaving an account matches the actual money spent. Further, with regard to a bank account, reconciliation is the procedure for confirming that the balance in a chequebook matches the corresponding bank statement. This includes matching the entries in a bank statement to payments or receipts of the account holder.

In the example illustrated in FIG. 1, a payer 102 sends a payment 112 (e.g., a check) to a payee 104. In some cases, the payment is associated with an invoice sent by the payee 104, and at other times the payment is not associated with an invoice (e.g., paying a taxi by credit card).

The payee 104 remits the payment 112 to a financial institution 114 (e.g., bank or credit card company) to charge 116 the payer's account associated with the payer's bank 106, which receives charges from a plurality of sources. The financial institution 114 then includes the payment as an entry in the bank statement 108 sent to the payer 102 or to the payer accounting service 110. In some embodiments, the payer 102 or the payer accounting service 110 may be equipped to receive financial information including bank statement entries in the form of a bank feed, as discussed in more detail below.

During reconciliation 118, for each transaction 120, the payer 102 has to identify the transaction description and amount to identify the accounting data 122, which may include the corresponding payee, the account in the accounting system, the amount in the accounting system, and/or other fields, such as tax rate, tax amount, and the like. Sometimes, there may already be a corresponding entry in the accounting system, but at other times a new entry has to be created.

Often, the challenge is to reconcile the entry based on a short or cryptic description in the bank statement, which may make reconciling a long, tedious, and boring task, where mistakes may take place. The goal of the accounting service is to make reconciliation an easy task (for example, by offering suggestions to the user based on the bank statement). For example, the amount may be a good indicator for generating suggestions by matching the amount to an entry in the accounting system. However, matching based on amount does not always work because there may not be an entry in the accounting system yet or because the payer may consolidate multiple payments into one single check. While some times the name of the payee may be included in the statement, many times the name of the payee is not included, and instead there is a description of the service, such as “Taxi Service” or “Entertainment.” In addition, different financial institutions may format their respective bank statements and/or feeds in different manners. These are some of the reasons why performing automatic reconciliation of bank statements in the accounting system may be difficult and manual reconciliation is required. Some solutions for reconciliation are based on defining rules for reconciliation, such as, “If the entry includes ‘taxi’ then the account is 2547 and add a new accounting entry.” However, rules are difficult for reconciling a large amount of statements. Rules are also inconvenient because someone has to create and maintain the rules.

Embodiments presented herein are described with reference to reconciling a received payment, but the same principles may be utilized for reconciling payments made.

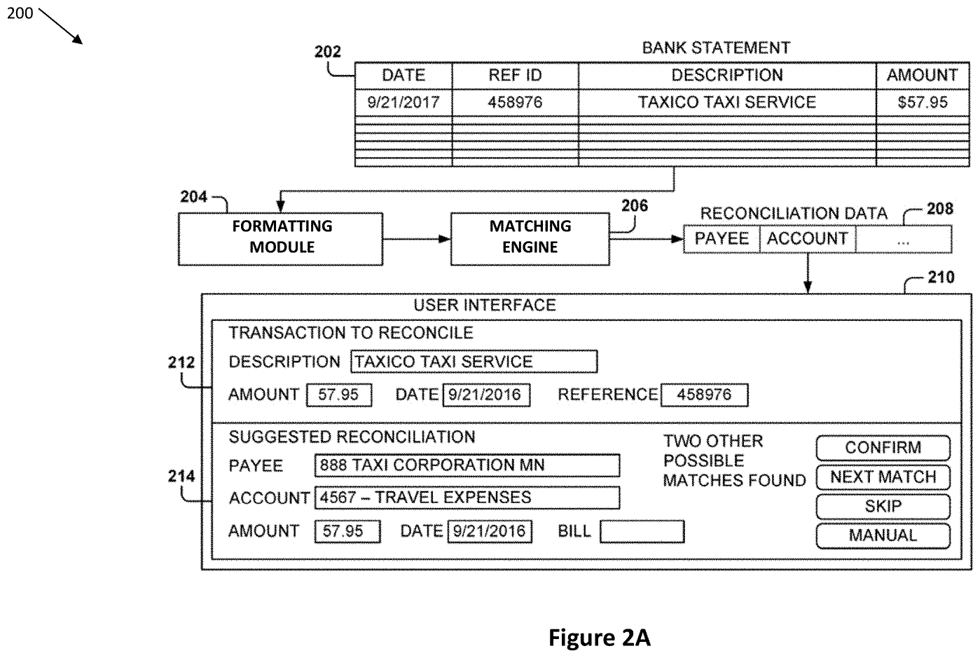

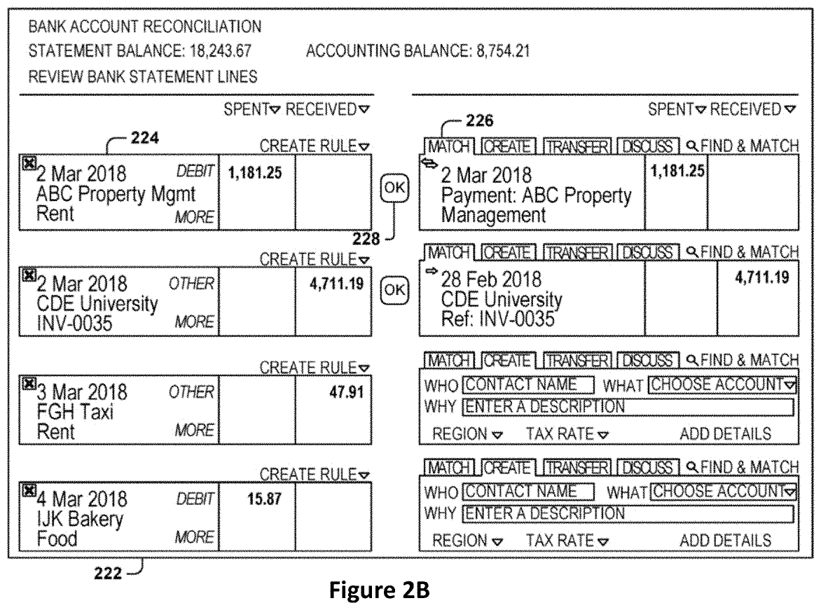

FIG. 2A illustrates the process 200 for using a matching engine 206 to reconcile a transaction, for example, as may be extracted from financial information such as a bank statement or a bank feed 202, according to some example embodiments. A bank statement or bank feed 202 includes a plurality of entries, and each entry may include a date of the transaction, a reference identifier for the accounting system, a description, and/or an amount. Embodiments presented herein make reconciliation easy by providing suggestions to the user or by automatically reconciling without user intervention when the system identifies the nature of the entry in the financial information to a sufficient degree of certainty (for example, greater than a threshold amount).

In some example embodiments, a matching engine 206 is used to analyse financial documents or records, such as a bank statement entry, also referred to herein as bank entry or entry, to generate suggestions or automatically reconcile with accounting documents or records associated with transactions. The description from the bank statement entry and/or accounting documents may be first formatted to convert it into a format suitable for inputting into the matching engine (operation 204). For example, the description may be cleaned by eliminating predefined characters, such as punctuation marks (e.g., “/”) and/or predefined words, (e.g., INV, Pty, Ltd. etc.), to convert all letters of the description to lowercase, and/or normalised to use a representative word for a family of words with the same meaning (e.g., reducing grammatical forms into a single form, such as transforming words “likes,” “liked,” “liking,” and “like” to “like,” a process referred to as stemming). In some embodiments, the description may be pre-processed to determine alphanumeric words, and to modify the description to add each numeral string and alphabet string to the description.

The financial documents and/or accounting documents (in some embodiments, the formatted versions) are input into the matching engine 206 to cause the matching engine 206 to generate reconciliation data 208. The reconciliation data 208 may include one or more suggestions for reconciling the bank entry, where each suggestion includes at least the payee, the account, and the amount. The reconciliation data 208 may include accounting data associated with a transaction with which the bank entry has been automatically reconciled.

As shown, in some example embodiments, a user interface 210 is utilized to present the suggestions to the user. The user interface 210 includes a transaction to be reconciled 212 (e.g., the entry in the bank statement or bank feed) and a suggested reconciliation 214. The transaction to be reconciled 212 may include a description (e.g., the description from the bank entry or a cleaned up version), the amount, the date, and/or a reference identifier. The suggested reconciliation 214 may include fields for the payee, the account, the amount, the date, and/or a bill. The suggested reconciliation 214 may further include buttons for selecting an action by the user and an informational message about the transaction (e.g., “two other possible matches found”). The buttons may include a “confirm” button for accepting the suggestion, a “next match” button for requesting presentation of the next suggestion, a “skip” button for skipping this entry and proceeding to the next entry, and/or a “manual” option for entering data manually to reconcile the bank entry. In some embodiments, the suggested reconciliation 214 may include a ComboBox control item, which displays only one item from a group at a time, with other items from the group only becoming visible once the ComboBox control item is selected. Once the ComboBox control item is selected, a user may select any one of the items of the group. So, for example, a ComboBox control item may only display the “confirm” button, but if the ComboBox control item is selected, other items of the group such as a “next match” button, a “skip” button, and/or a “manual” option are made visible. In some embodiments, the suggested reconciliation 214 may include a drop down list of options for display, allowing a user to select and confirm the selection, for example, by clicking a “confirm” button.

In some cases, the financial information may result in the reconciliation of several accounting entries (e.g., payment of several invoices with one cheque and/or payment) and the multiple entries can be presented to the user indicating that the one payment correlates to several accounting entries.

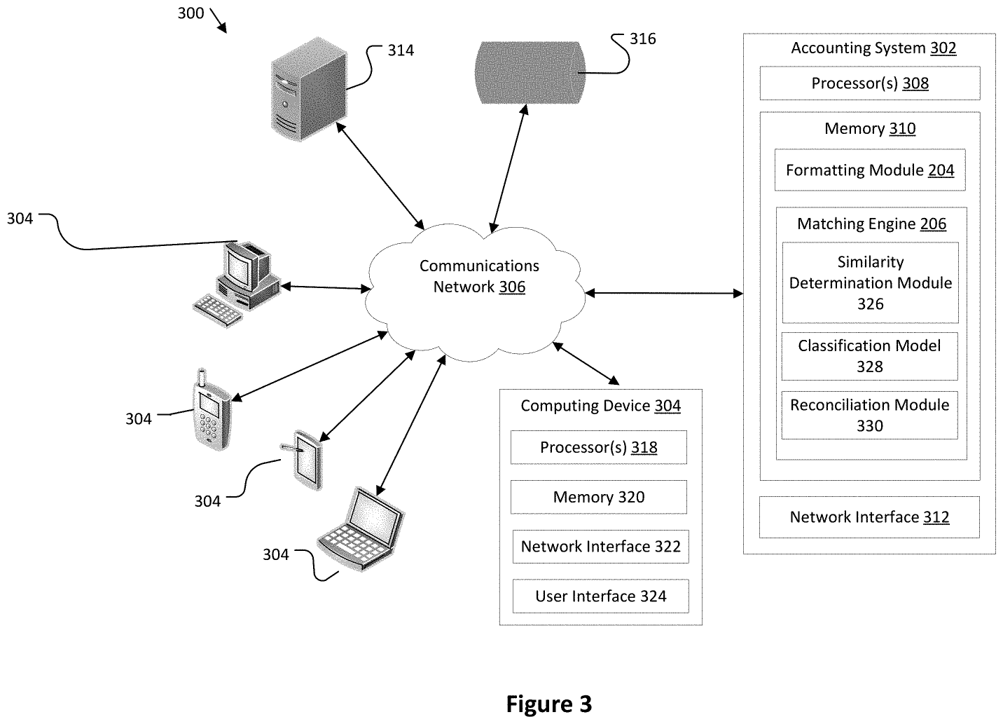

FIG. 2B is a user interface 222 for reconciling transactions, according to some example embodiments. In some embodiments, the user interface 222 is generated by one or more processors (308, FIG. 3) of an accounting system (302, FIG. 3) executing instructions stored in memory 310, FIG. 3) of the accounting system 302. The user interface 222 presents a plurality of financial records or transactions to be reconciled 224 (e.g., entries in the bank statement or bank feed) and suggested reconciliations 226 from the accounting system 302.

In this example, each transaction to be reconciled 224 includes one or more of the date of the transaction (e.g., 2 Mar. 2018), the name of the party in the transaction (e.g., ABC Property Management), reference information (e.g., Rent), and the amount (e.g., 1,181.25), which may be an amount spent or an amount received. However, it will be appreciated that it is often the case that any one or more of these attributes can be truncated or misspelt, and/or concatenated and in some cases, it may not be readily apparent which character string(s) relate to which attributes. For example, it may not be discernible whether a particular character string relates to the name of a party of the reference. Additionally, the transaction to be reconciled 224 includes an option for deleting the transaction and an option for creating a rule to handle this type of transactions. It is to be noted that the accounting system 302 may also create rules over time based on past reconciliations made by users, where the rules for a certain type of entry may be reconciled to a certain account if the user performs the same reconciliation one or more times to match the entry in the bank statement to the account. Further, in addition to the option to add rules, the user has options to modify or delete rules, even those rules that are created automatically by the accounting system 302.

As illustrated, the suggested reconciliations 226 include four tabs: match, create, transfer, and discuss. The match tab is presented when the accounting system has one or more suggested reconciliation entries. The match entry includes a date, a description (e.g., Payment: ABC Property), reference information (e.g., Management), the amount in the spent or the received sections, and a find option to search other entries in the accounting system 302 for reconciliation.

A reconcile button 228 (e.g., including a message “OK” to indicate that the entries match) is provided as an option, and if the user selects the reconcile button 228, the transaction to be reconciled 224 will be reconciled with the suggested reconciliation 226.

When there are multiple match entries available as suggestions for reconciling a particular transaction, a message (e.g., a link) is shown to the user about alternative matches found. In response to the user selecting the message, the user is taken to a “Find & Match” tab, to allow the user to manually find and select the correct entry for reconciling with the transaction. For each transaction (i.e., statement line), there will be at least one candidate transaction (i.e., accounting entry) to which to reconcile to. However, there may also be multiple transactions of a similar or same amount having multiple candidate entries to which to reconcile to. Accordingly, based on the number of transactions and entries, the match suggestions may be described as “One to One” (where a single financial record (e.g. statement line) is provided with a single entry with which to reconcile to), “One to Many” (where a single financial record (e.g. statement line) is provided with a plurality of entry options with which to reconcile to), and “Many to Many” (where a plurality of financial records (e.g. statement lines) are provided with a plurality of entry options with which to reconcile to).

If the user prefers to create a new accounting entry for reconciliation, the create tab may be selected. The create tab may also be automatically presented if the accounting system 302 does not find a suggestion for reconciling an entry. The create tab includes options for entering the name or party of the transaction, the account, the description, the region, the tax rate, and adding additional details for the transaction. After the user enters the information, the reconcile button 228 is presented and the user may then reconcile the transaction with the created new entry.

The transfer tab can be selected to mark when the transaction is the result of transferring money between bank accounts of the user, where both bank accounts are linked to the accounting system. If one of the bank accounts is not in the accounting system, a create operation may be used instead of the transfer.

The discuss tab allows the user to leave a message for other users and discuss the reconciliation of the transaction. For example, the user may enter, “I don't know how to code this,” and another user (e.g., an accountant) may see the message and enter the details for the transaction.

It is noted that the embodiments illustrated in FIGS. 2A and 2B are examples and do not describe every possible embodiment. Other embodiments may utilise different layouts for the user interface, different fields, and additional fields, present more than one suggestion at a time, and so forth. The embodiments illustrated in FIGS. 2A and 2B should therefore not be interpreted to be exclusive or limiting, but rather illustrative.

FIG. 3 is a schematic of a communications system 300 comprising an accounting system 302 in communications with one or more computing devices 304 across a communications network 306. Examples of a suitable communications network 310 include a cloud server network, wired or wireless internet connection, Bluetooth™ or other near field radio communication, and/or physical media such as USB.

The accounting system 302 comprises one or more processors 308 and memory 310 storing instructions (e.g. program code) which when executed by the processor(s) 308 causes the accounting system 302 to manage accounting aspects for a business or entity, provide accounting functionality to the one or more computing devices 304 and/or to function according to the described methods. The processor(s) 308 may comprise one or more microprocessors, central processing units (CPUs), application specific instruction set processors (ASIPs), application specific integrated circuits (ASICs) or other processors capable of reading and executing instruction code.

Memory 310 may comprise one or more volatile or non-volatile memory types. For example, memory 310 may comprise one or more of random access memory (RAM), read-only memory (ROM), electrically erasable programmable read-only memory (EEPROM) or flash memory. Memory 310 is configured to store program code accessible by the processor(s) 308. The program code comprises executable program code modules. In other words, memory 310 is configured to store executable code modules configured to be executable by the processor(s) 308. The executable code modules, when executed by the processor(s) 308 cause the accounting system 302 to perform certain functionality, as described in more detail below.

The accounting system 302 further comprises a network interface 312 to facilitate communications with components of the communications system 300 across the communications network 306, such as the computing device(s) 304, database 314 and/or other servers, including financial institute or banking server 316. The network interface 312 may comprise a combination of network interface hardware and network interface software suitable for establishing, maintaining and facilitating communication over a relevant communication channel.

The computing device(s) 304 comprise one or more processors 318 and memory 320 storing instructions (e.g. program code) which when executed by the processor(s) 318 causes the computing device(s) 304 to cooperate with the accounting system 302 to provide accounting functionality to users of the computing device(s) 304 and/or to function according to the described methods. To that end, and similarly to the accounting system 302, the computing devices 304 comprise a network interface 322 to facilitate communication with the components of the communications network 306. For example, memory 320 may comprise a web browser application (not shown) to allow a user to engage with the accounting system 302. In some embodiments, memory 320 may comprise a reconciliation application (not shown) associated with the accounting system 302, which when executed by processor(s) 318, enable the computing device 304 to allow a user to reconcile a business's records with banking records associated with one or more accounts of the business via interaction with the user interface 324.

The communications system 300 further comprises the database 314, which may form part of or be local to the accounting system 302, or may be remote from and accessible to the accounting system 302. The database 314 may be configured to store business records, banking records, accounting documents and/or accounting records associated with entities having user accounts with the accounting system 302, availing of the services and functionality of the accounting system 302, or otherwise associated with the accounting system 302.

The accounting system 302 may also be arranged to communicate with financial institute server(s) 316 or other third party financial systems (not shown) to receive financial records and/or financial documents associated with transactions for reconciliation. For example, in some embodiments, the accounting system 302 may be arranged to receive bank feeds having line items (or financial data items) associated with transactions to be reconciled by the matching engine 206 of the accounting system 302. The financial institute server(s) 316 may provide an Application Programming Interface (API) to securely extract transaction information in relation to one or more bank accounts of a business. The APIs may be secured using authentication and encryption mechanisms and the extracted transaction data may be referred to as bank feed data. Bank feed data may comprise information regarding one or more transactions, including transaction data, transaction amount, transaction reference, for example.

According to some described embodiments, memory 310 comprises the matching engine 206, which when executed by the processors(s) 308, causes the accounting system to compare financial records with accounting records with a view to providing suggestions to a user, via user interface 324, for reconciling a given financial data item with a given accounting data item from an accounting record, or to automatically reconcile the given financial data item with a given accounting data item, as discussed in more detail below. The matching engine 206 comprises a similarity determination module 326 and a classification model 328.

In some situations, financial records and/or accounting records include characters and character strings that are truncated, misspelt, fragmented and/or concatenated, and may also include erroneous additional characters or character strings, and/or omit relevant information or fragments of information, including, for example, references, names, contacts, numbers etc. Accordingly, it can be difficult to determine with any certainty, whether a financial record matches with a particular accounting record.

The similarity determination module 326 is configured to determine suitable input values from the financial record to be reconciled and a candidate accounting record for inputting into the classification model 328. In some embodiments, the input values may be similarity measures, such as text similarity measures, which are used as feature values for the classification model 328. The similarity determination module 326 outputs values for the similarity measures, which are provided as inputs to the classification model 328.

For example, in some embodiments, the similarity determination module 326 performs a bi-directional partial matching process, determining the similarity of financial data extracted from the financial document to be reconciled, with accounting data extracted from a candidate accounting record (first direction matching step), and determining the similarity of the accounting data with the financial data (second direction matching step). For example, the similarity determination module 326 may determine, as a value for a first feature, a sum of the length of character strings, (e.g. words) from the text of the financial record (e.g. statement line's text) that appear, or partially appear, in the text of the accounting record (e.g. transaction), and the similarity determination module 326 may determine, as a value for a second feature, a sum of the length of character strings, (e.g. words) from the text of the accounting record that appear, or partially appear, in the text of the financial record.

In some embodiments, the similarity determination module 326 determines a number of common character strings between the financial record (or a data item determined from the financial record) and the candidate accounting record (or a data item determined from the accounting record), i.e., the number of character strings that appear in data items of both financial record and the candidate accounting record.

In some embodiments, the similarity determination module 326 determines a sum of the length of all common character strings between the financial record (or a data item determined from the financial record) and the candidate accounting record (or a data item determined from the accounting record), i.e., the number of character strings that appear in data items of both financial record and the candidate accounting record. This embodiment has the advantage of adding specificity in that longer character strings are more specific and common longer character strings are potentially more likely to be indicative of a better match.

In some embodiments, the similarity determination module 326 determines an absolute date difference between a date extracted from the financial record (or a data item determined from the financial record) to be reconciled and a date extracted from the candidate accounting record (or a data item determined from the candidate accounting record). An absolute date difference feature as an input to the classification model 328 has an advantage of assisting not selecting candidate accounting records for reconciliation that might have a significant time difference, and accordingly may be determined as being unlikely to relate to the same transaction. Generally, the closer in time the date extracted from the financial record and the date extracted from the candidate accounting record are, the more likely it is that the financial record and candidate accounting record are a match. In particular, where the date extracted from both records is the same date, there is a much greater probability that the records are a match. In some embodiments, the similarity determination module 326 determines an absolute date difference as an additional step in situations where two or more candidate accounting records have the same or similar (within a predefined threshold) probabilities of being a match to determine which of the two or more candidate accounting records should be selected for automatically reconciling the financial record or providing as the suggestion for reconciling the financial record.

In some embodiments, the similarity determination module 326 determines a due date associated with the accounting record, such as a date by which an invoice is due to be paid. Due date as an input to the classification model 328 has an advantage of assisting not selecting candidate accounting records for reconciliation that might be well overdue, or not due for a significant period of time, and accordingly may be determined as being unlikely to relate to the same transaction. Similarly to the absolute date difference, the similarity determination module 326 may determine the accounting record due date as an additional step in situations where two or more candidate accounting records have the same or similar (within a predefined threshold) probabilities of being a match to determine which of the two or more candidate accounting records should be selected for automatically reconciling the financial record or providing as the suggestion for reconciling the financial record. In some embodiments, both the absolute date difference and the due date are both used, and in some cases, with the absolute data difference being given more weight than the due date.

The similarity determination module 326 may be configured to use one of these embodiments alone, or to combine features from select embodiments to determine inputs for the classification model 328.

The classification model 328 is configured to receive the input values from the similarity determination module 326 and output an indication of a probability of the candidate accounting record being a suitable match for the financial record to be reconciled, i.e., an indication of the probability of the financial record and the candidate accounting record being associated with the same or a common transaction.

The matching engine 206 may further comprise a reconciliation module 330 configured to receive outputs (e.g., scores) from the classification model 328 and generate suggestions for reconciling the financial record, and/or automatically reconcile the financial record with a candidate accounting record based on the scores.

In some embodiments, memory 310 also comprises a formatting module 204 configured to normalise, filter and/or pre-process financial records, or financial data items, and/or accounting records, or accounting data items, prior to providing the records or data items to the matching engine 206. For example, the formatting module 204 may be configured to remove predefined special characters or predefined special character strings from the data items, to convert the characters of the data items into a uniform form or case, for example lowercase or uppercase, and/or to split up alphanumeric strings into letter strings and number strings, as discussed in more detail below.

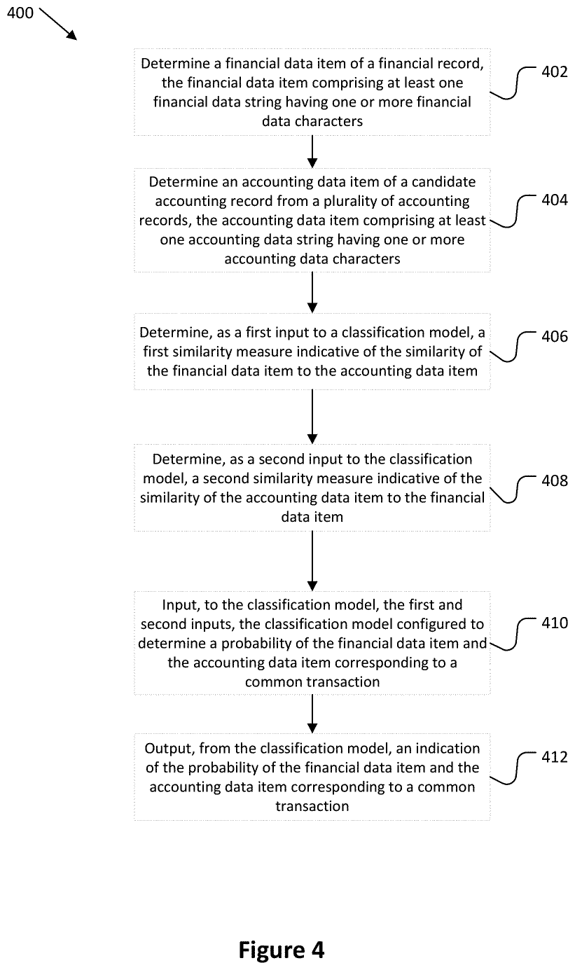

FIG. 4 is a process flow diagram of a method 400 for reconciling transactions, according to some embodiments. The method 400 may, for example, be implemented by the processor(s) 308 of accounting system 302 executing instructions stored in memory 310.

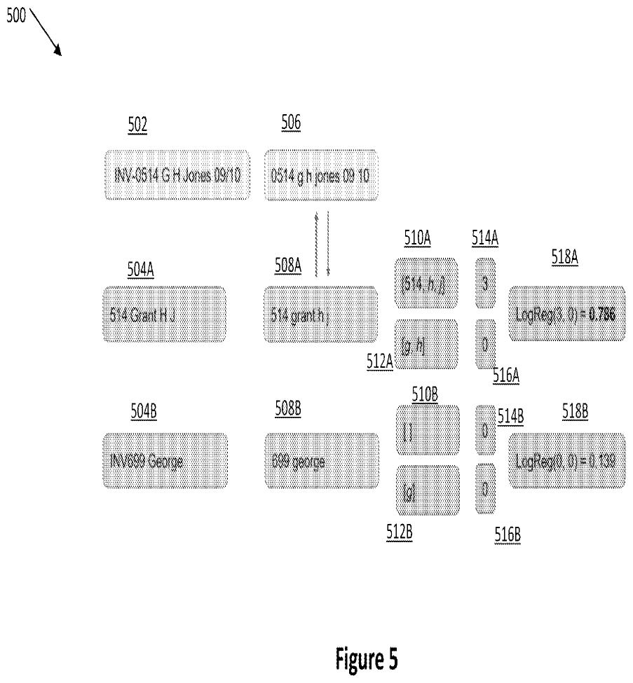

At 402, the accounting system 302 determines a financial data item (502 of FIG. 5) of a financial document, such as a line entry of a financial statement or a feed from a bank or financial institution received by or accessible to the accounting system 302. The financial data item 502 comprises at least one financial data string having one or more financial data characters. The financial data item may comprise information including one or more of: payee, amount, posted date, cheque number, reference, and/or notes; the financial data item may comprise information in the format: “Payee”+“Notes”+“Reference”+“Cheque number”. Indeed, the financial data item may only comprise fragments of information, such as information that is only partially indicative of any of these attributes. For example, and as illustrated in the schematic example 500 of FIG. 5, the financial data item 502 comprises five financial data strings (‘INV-0514’, ‘G’, ‘H’, ‘Jones’, and ‘09/10’), each having one or more financial data characters (eight, one, one, five and five, respectively).

At 404, the accounting system 302 determines an accounting data item (504A, 504B of FIG. 5) of an accounting document, such as an accounting record of an individual or a business, or entity. The accounting document or record may be a candidate accounting record selected from a plurality of such accounting records accessible and/or maintained by the accounting system 302, as may be stored in database 316. The accounting data item 504A, 504B comprises at least one accounting data string having one or more accounting data characters. The accounting data item may comprise information including one or more of: payee, date, invoice number, reference, due date, cheque number, and/or amount; the accounting data item may comprise information in the format: “Payee”+“Invoice number”+“Reference”+“Cheque number”. Indeed, the accounting data item may only comprise fragments of information, such as information that is only partially indicative of any of these attributes. For example, and as illustrated in the schematic example 500 of FIG. 5, the accounting data item 504A comprises four accounting data strings (‘514’, ‘Grant’, ‘H’ and T) each having one or more accounting data characters (three, five, one and one, respectively). The accounting data item 504B comprises two accounting data strings (‘INV699’, and ‘George’) each having one or more accounting data characters (six and six, respectively).

In some cases, one or more attribute types or fields of information of the financial data item and/or accounting data item are joined or concatenated together. For example, the financial data item may comprise information in the format: “Payee”“Notes”“Reference”+“Cheque number”, where distinct data strings for each of the attributes payee, notes and reference have been concatenated or joined together into a single data string. That is, it may not be readily discernible which data string(s) relate to which attribute(s). In some embodiments, the accounting system 302 determines each of the financial data items and/or the accounting data items as information combined from all attribute fields, and/or of all attribute types, and processes it as a single data item comprising data string(s) of information. In other words, in some embodiments, the accounting system 302 does not attempt to determine financial or accounting type attributes associated with the data strings, or input that type of information into the formatting module 204 or matching engine 206.

In some embodiments, a formatting module 204 of the accounting system 302 formats the financial data item 502 and/or the accounting data item 504A, 504B prior to inputting the formatted financial data item 506 and/or the accounting data item 508A, 508B into the matching engine 206. For example, the data strings of the financial data item 502 and/or the accounting data item 504A, 504B may be normalised. In some embodiments, the formatting module 204 is configured to normalise the data strings by converting all letters in the financial data string and/or accounting data string to lowercase letters. The formatting module 204 may be configured to filter data strings of the financial data item 502 and/or the accounting data item 504A, 504B to remove occurrences of predefined special strings of characters or symbols and/or predefined special characters or symbols. For example, predefined special strings of characters and/or predefined special characters may be stored in a character library in the database 316, and the data strings may be compared with the character library to identify and delete instances of predefined special strings of characters and/or predefined special characters in the data strings. Predefined special character strings may include Ltd., Pty, Inv etc. Predefined special characters may include punctuation marks or symbols such as #, %, $, /, * etc. The formatting module 204 may be configured to format or standardise space characters to single spacing.

The formatting module 204 may be configured to pre-process the financial data item and the accounting data item to split identified alphanumeric words into letters and numbers. In some embodiments, the formatting module 204 determines data strings of the financial data item or accounting data item that comprise alphanumeric words and for each determined alphanumeric word, modifies the financial data item or accounting data item to include a new data string for each numeral string (i.e., each numeral string comprising consecutive numerals) of the alphanumeric word and a new data string for each alphabet string (i.e., each alphabet string comprising consecutive letters) of the alphanumeric word. In other words, the formatting module 204 may parse the alphanumeric words of the data strings to determines sets of sub-strings, each sub-string being composed wholly of numerals or letters such that each sub-string corresponds with a data string comprising consecutive letters or consecutive numerals, For example, where the financial data item is “My30th2020”, the formatting module 204 may modify or convert the financial data item to “My30th2020 My 30 th 2020”. If a match for that alphanumeric word is identified in an accounting data item, then there is a greater likelihood that the associated financial and accounting records belong to the same transaction. Where a similarity measure of the financial data item to the accounting data item depends on character string length (discussed in more detail below), the probability determined by the classification model 328 will be greater for having included the original alphanumeric word.

In some embodiments, the formatting module 204 also deletes the original alphanumeric word from the data string. In some embodiments, numeral strings and alphabet strings are given different weightings by the similarity determination module 326 in determining first and second similarity measures for inputs to the classification model 328 as discussed below. In other embodiments, the numeral strings and alphabet strings are given the same weightings by the similarity determination module 326.

The similarity determination module 326 is configured to determine first and second inputs for the classification model 328 of the matching engine 206 based on the financial data string and the accounting data string (and in some embodiments, the formatted financial data string and the formatted accounting data string).

At 406, the similarity determination module 326 determines the first input as a first similarity measure indicative of the similarity of the financial data item to the accounting data item, such as text similarity. In some embodiments, the first similarity measure may comprise a sum of the length of financial data strings of the financial data item that have at least two financial data characters present in the at least one accounting data string of the accounting data item. In other words, the similarity determination module 326 may be configured to determine if there are any financial data strings of the financial data item 502, 506 that have at least two characters present or appearing in one or more of the accounting data string of the accounting data item. If there are one or more, the similarity determination module 326 is configured to sum the length of the determined data strings that appear fully or partially (i.e., at least two characters). For example, referring again to FIG. 5, in this example it is determined that a subset 510A of financial data strings [514, h, j] of the formatted financial data item 506 appear in the formatted accounting data item 508A, but that only financial data string “514” comprises at least two characters. Accordingly, the first input is the length of the string “514”, i.e., three. In this example, it is also determined that a subset 510B of financial data string of the formatted financial data item 506 appearing in the formatted accounting data item 508B is a null set, and according, the first input is zero.

At 408, the similarity determination module 326 determines the second input to the classification model, as a second similarity measure indicative of the similarity of the accounting data item to the financial data item, such as text similarity. In some embodiments, the second similarity measure may comprise a sum of the length of accounting data strings of the accounting data item that have at least two accounting data characters present in the at least one financial data string of the financial data item. In other words, the similarity determination module 326 may be configured to determine if there are any accounting data strings of the accounting data item 504A, 504B, 508A, 508B that have at least two characters present or appearing in one or more of the financial data string of the financial data item 502, 506. If there are one or more, the similarity determination module 326 is configured to sum the length of the determined data strings that appear fully or partially (i.e., at least two characters). For example, referring again to FIG. 5, in this example it is determined that a subset 512A of accounting data strings [g, h] of the formatted accounting data item 508A appear in the formatted financial data item 506, but that neither comprise at least two characters. Accordingly, the second input is zero. In this example, it is also determined that a subset 512B of accounting data string [g] of the formatted accounting data item 508B appears in the formatted financial data item 506, which again comprises only a single character, and according, the second input is also zero.

Thus, in the example of FIG. 5, the similarity determination module 326 determines the first input value of three and a second input value of zero for the transaction pair financial data item 502 and accounting data item 504A, and the similarity determination module 326 determines the first input value of zero and a second input value of zero for the transaction pair financial data item 502 and accounting data item 504B.

In some embodiments, the similarity determination module 326 determines that certain data or character strings of the financial records and/or the accounting records are more important or more indicative of how to best reconcile the transactions, and may be given more weight than other character strings. For example, alphabet strings may be given more weight than numeral strings or vice versa. In some embodiments, the similarity determination module 326 may, for example, apply a first weighting to alphabet strings and a second weighting to numerical strings before summing the length of the strings to determine the first and/or second similarity measures.

At 410, the similarity determination module 326 of the accounting system 302 provides or inputs the first and second inputs to the classification model 328. The classification model 328 is configured to determine a probability of the financial data item and the accounting data item corresponding to a common transaction.

In some embodiments, the classification model 328 is a logistic regression model. A logistic regression model, as opposed to more sophisticated model, is an appropriate model for selection as the similarity determination module 326 due to its technical simplicity (for example, it is relatively easy to implement), the nature of the output (i.e., indicative of a match or no match, and therefore easy to interpret), and it is relatively quick to produce an output. Furthermore, in view of an assumption that there is likely to be a relatively high number of common character strings (or character strings fragments) between matching financial records (e.g., statement lines) and accounting records, the features for text similarity have a positive correlation with the probability of a correct match (that is, the higher their value, the more likely they are a match). Accordingly, the correlation is assumed to be linear, satisfying the considerations of Logistic Regression.

For example, the logistic regression model may take the form:

$$p = {( 1 + {e}^{- ( \begin{matrix}{β}_{0} + {\sum }_{i = 1 … n} & {β}_{i} {x}_{i} )\end{matrix}} )}^{- 1}$$

where p is the probability of the output being True, β₀ is the bias, βᵢ is the coefficient of feature i, xᵢ the value of feature i, and n is the number of features.

In some embodiments, the logistic regression model may take the form:

$$p = \frac{1}{( 1 + {e}^{( - ( a + {bx}_{1} + {cx}_{2} ) )} )}$$

where x₁ is the feature of the sum of the lengths of character strings from the text of the financial record that appear, or partially appear, in the text of the accounting record and x₂ is the sum of the lengths of character strings from the text of the accounting record that appear, or partially appear, in the text of the financial record, and a, b, and c are constants determined by training the similarity determination module 326. In some embodiments, the second feature (x₂), that is, the sum of the length of character strings from the text of the accounting record that appear, or partially appear, in the text of the financial record, is given a higher weighting than the first feature, indicating that it is more important for character strings from the accounting record to appear in the financial record than vice versa. However, in other embodiments, both the first and second features may be equally weighted. In yet further embodiments, the first feature may be weighted more highly than the second feature, indicating that it is more important that character strings from the financial record appear in the accounting record than vice versa.

At 412, the classification model 328 outputs a score or an indication of the probability of the financial data item and the accounting data item corresponding to a common transaction.

In some embodiments, the accounting system 202 is configured to determine a subsequent candidate accounting record from the plurality of accounting records, and to perform steps 404 to 412 on the subsequent candidate accounting record to determine a potential further suggestion or automatic reconciliation of the financial record with the further candidate accounting record.

In some embodiments, the matching engine 206 comprises the reconciliation module 330. The reconciliation module 330 is configured to receive outputs (e.g., scores) from the classification model 328 and generate suggestions for reconciling the financial record, and/or automatically reconciling the financial record with a candidate accounting record based on the scores. For example, the suggestion may comprise the name of an entity in the transaction and an account associated with the transaction, and the suggestion may be displayed on the user interface 324 of the computing device 304.

The indication of the probability of the financial data item and the accounting data item of the or a subsequent candidate accounting record corresponding to a common transaction may be received by the reconciliation module 330 and compared with one or more thresholds. In some embodiments, the scores or indications of probability are compared with a first threshold, and responsive to the score meeting the first threshold, the reconciliation automatically reconciles the financial record with the candidate accounting record. In some embodiments, the scores or indications of probability are compared with both a first threshold and second threshold, and responsive to the score meeting the second threshold but falling short of (not meeting) the first threshold, generating a suggestion for reconciliation of the financial record based on the candidate accounting record, i.e., suggesting to the user, the candidate account record as a suggestion for reconciling the financial record. Further, in some embodiments, where the score falls short or doesn't meet either the first or second threshold, the candidate accounting record is considered to be too dissimilar to the financial record to be considered a match for reconciliation purposes, and is not used for automatic reconciliation or for generating a suggestion to the user.

In some embodiments, the reconciliation module 330 may determine a plurality or set of potential suggestions (i.e., a plurality of candidate accounting records) for reconciling the financial record (i.e., the “One to Many” situation) and/or the reconciliation module 330 may determine a plurality of potential suggestions for reconciling a plurality or set of financial records ((i.e., the “Many to Many” situation).

Where a “One to Many” situation arises, the reconciliation module 330 may be configured to rank pairs of the financial record and candidate accounting records according to the probability or score determined by the classification model 328, and to select the pair with the highest score. In cases where there are two or more candidate accounting records with the same highest score, the reconciliation module 330 may consider the absolute date difference between the posted date of the financial record and the due date of the accounting record (i.e. the absolute date difference) and/or the due date of the account records to determine a more likely match. For example, the candidate account record having the smallest absolute date difference may be selected as a match for the financial record, and/or the candidate account record with the earliest due date. In some embodiments, if neither of these measures is decisive, the first candidate account record on the list (i.e. in order of appearance) is selected as a match.

Where a “Many to Many” situation arises, the reconciliation module 330 may be configured to rank pairs of financial records and candidate accounting records according to the probability or score determined by the classification model 328, and sort the pairs in descending order, from most likely to least likely. Starting with the highest ranked pair, the reconciliation module 330 may assign or match the financial record to the candidate accounting record of the pair, provided that the accounting record of the pair has not already been assigned to a different financial record, and the financial record of the pair has not already been assigned to a different accounting record. It will be appreciated that in situations where there are more financial records than accounting records, one or more financial records may remain unreconciled, and similarly, where there are more accounting records than financial records, one or more accounting records may remain unreconciled

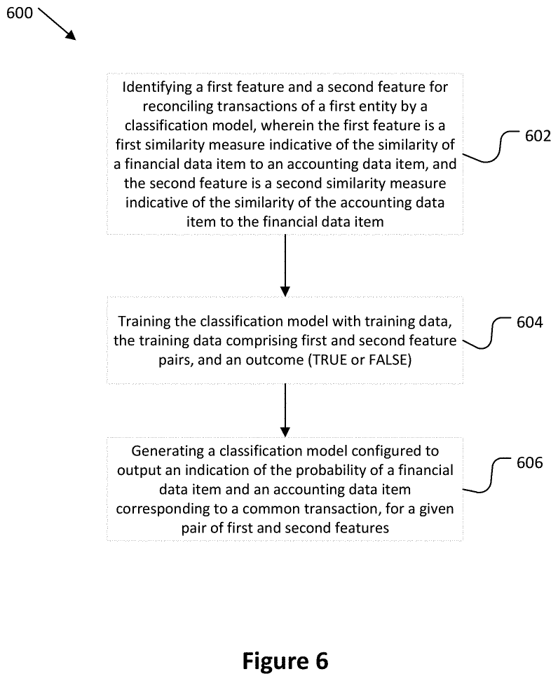

FIG. 6 is a process flow diagram of a method 600 for training a classification model 328 for reconciling transactions, according to some embodiments. The method 600 may be executed by the processor(s) 308 of the accounting system 302 to generate the classification model 328 or it may be generated elsewhere and provided to the accounting system 302 for performing method 400.

At 602, a first feature and a second feature are identified for reconciling transactions of a first entity. The first feature is a first similarity measure indicative of the similarity of a financial data item of a financial record to be reconciled to an accounting data item of a candidate accounting record of a plurality of accounting records. The second feature is a second similarity measure indicative of the similarity of the accounting data item to the financial data item. The first and second features are identified or selected to cause the trained classification model to output a relatively high value when the financial data item and accounting data item are a correct match, and a relatively low value when they are not.

At 604, the a classification model, such as a logistic regression model, is trained using training data, to determine a score or indication of the probability of a given accounting record and a candidate accounting record being associated with a common (i.e., the same) transaction; in other words, how likely it is for the pair to be a match.

The dataset used to train the classification model 328 comprises a plurality of examples, each comprising a pair of a financial record and accounting record and a matching outcome, i.e., an indication of whether the pair was matched (i.e., reconciled) or not—True or False. The examples were based on information about prior reconciled transactions available to the accounting system 302. The accounting system 302 generated suggestions for reconciling transactions using a prior art solution, and those suggestions were stored by the accounting system 302 in a candidate pool. Once the user selected a suggestion for reconciliation with a particular financial record, the reconciled transaction pair (i.e., the reconciled financial record and accounting record) were also stored by the accounting system 302 in a reconciliation pool. By combining the suggestions and the ultimate reconciled accounting records for a given financial record, it was possible to determine whether users of the accounting system reconciled transactions in accordance with the system suggestions. Thus, each example in the dataset represents a pair of a financial record and an accounting record, where its outcome or target is True when the candidate accounting record (or accounting data item) is equal to the reconciled transaction (reconciled accounting data item) and False otherwise.

More specifically, the dataset used for training (and testing purposes) comprises a plurality of rows, each comprising (a) the first and second features for a pair of a financial record and a candidate accounting record transaction, and (b) its respective Boolean output indicating whether the pair was considered a correct match based on prior users' choice of reconciliation. The dataset comprised 300 files comprising the candidate pools and reconciliation events. The dataset was split in two to allow for both training and testing. The training dataset is used for learning the mapping of features to targets, and the testing dataset is used to measure the quality of the learning. The training dataset contained 812,439 pairs of financial records and accounting records, and the testing dataset contained 794,366 pairs. The overall proportion of positive and negative examples in the dataset was 33% and 67%, respectively.

In some embodiments, a base model, such as a logistic regression model, is fitted to the training data. Initial values for the coefficients may be provided by a pseudo random number generator. However, it will be appreciated that any initial values may be selected for the coefficients. The values of the coefficients are adjusted as the features of the training set examples are applied to the base model to achieve the associated target. Once the base model has been fitted to all of the examples of the training set, the tuned base model with the determined coefficients is considered to be the trained classification model.

In some embodiments, the trained classification model is evaluated using the testing dataset. For example, the trained classification model may be assessed for accuracy (i.e., classification rate), precision (i.e. percentage of correct prediction relative to the number of examples tested), and recall (i.e. sensitivity).

At 606, a trained classification model is generated that maps a pair of a financial data item and an accounting data item to a probability distribution indicating how likely they are to be a correct match.

An example of a dataset used to train the base model to produce the trained classification model is provided below in Table I. In the example, the term “S L” is used to refer to a statement line of a financial record, that is a financial data item, and the term “transaction” or “T” refers to an accounting data item of an accounting record. The entries in the “Taxonomy” column refer to the type of match suggestions that determined for any given financial data item, being, “One to One” (where a single statement line is provided with a single entry with which to reconcile to), “One to Many” (where a single statement line is provided with a plurality of entry or transaction options with which to reconcile to), and “Many to Many” (where a plurality of statement lines are provided with a plurality of entry or transaction options with which to reconcile to). The “amount” column indicates the amount indicated in the financial data item. The “SL ID” and the “T ID” refer to identifiers for each of the financial data items and the accounting data items. The “SL” and “Transaction” columns indicate the data strings that appeared in each of the financial data items and accounting data items, respectively. The “Words SL in T” column indicates the data strings of the financial data item that appear in the accounting data item, and the “Words T in SL” that appear in column indicates the data strings of the accounting data item that appear in the financial data item. The column “x_1” indicates the length of the data strings of the “Words SL in T” and the column “x_2” indicates the length of the data strings of the “Words T in SL”. The “Target” column indicates whether the financial data item and accounting data item of each row were reconciled or indicated to be a match by a user. The “Probability” column indicates a probability value determined by the trained classification model for the pairs of financial data item and accounting data item of each row; the likelihood of the match. It is noted that, in general, the trained classification model would be tested using a different test dataset to that of the training dataset, and that the probability values indicated in the “Testing” column are for reference only.

As exemplified in Table I, for the taxonomies of “One to Many” and “Many to Many”, the accounting data item with the highest probability is elected as the suggested accounting data item with which to match or reconcile the associated financial data item. It is noted that where there are no common data strings in the financial data item and accounting data item, a probability of 0.1813 was achieved. For other data items, every partial data string with 2 or more common characters contributes to a higher probability. It is further noted that in this example special character strings, such as noisy characters or character strings, likely to appear in many financial or accounting records, including “pay”, “ltd”, “inv” and “payment” were not filtered out and that different probabilities would be achieved had they been.

TABLE I

| | | | | | | | Words | | | Training | |
|---|---|---|---|---|---|---|---|---|---|---|---|
| | | SL | | T | | Words | Tin | | | Reconciled | Testing |
| Taxonomy | Amount | ID | SL | ID | Transaction | SL in T | SL | X | X2 | (Target) | Probability |
| One to One | $5.80 | SL1 | Purchase | T1 | Jane Doe | Jane | Jane | 4 | 7 | TRUE | 0.4183 |
| | | | Jane | | | | Doe | | | | |
| | | | Doellinger | | | | | | | | |
| One to | $19.99 | SL2 | Purchase | T2 | John Sm | John | John | 4 | 6 | FALSE | 0.3895 |
| Many | | | John | | | | Sm | | | | |
| | | | Smith | | | | | | | | |
| | $19.99 | SL2 | Purchase | T3 | John Smith | John | John | 9 | 9 | TRUE | 0.5831 |
| | | | John | | | Smith | Smith | | | | |
| | | | Smith | | | | | | | | |
| | $19.99 | SL2 | Purchase | T4 | Paul Smith | Smith | Smith | 5 | 5 | FALSE | 0.3814 |
| | | | John | | | | | | | | |
| | | | Smith | | | | | | | | |
| One to | $30.00 | SL3 | Purchase | T5 | Jane Smith | | | 0 | 0 | FALSE | 0.1813 |
| Many | | | Debit | | | | | | | | |
| | | | Card | | | | | | | | |
| | $30.00 | SL3 | Purchase | T6 | Paul Doe | | | 0 | 0 | TRUE | 0.1813 |
| | | | Debit | | | | | | | | |
| | | | Card | | | | | | | | |
| Many to | $2.11 | SL4 | Online | T7 | Pay lnv0823 | 823 Pay | | 3 | 3 | TRUE | 0.2905 |
| Many | | | Payment | | | | | | | | |
| | | | Ref823 | | | | | | | | |
| | $2.11 | SL4 | Online | T8 | Pay lnv0824 | | Pay | 0 | 3 | FALSE | 0.2407 |
| | | | Payment | | | | | | | | |
| | | | Ref823 | | | | | | | | |
| | $2.11 | SL5 | Internet | T7 | Pay lnv0823 | | Inv | 0 | 3 | FALSE | 0.2407 |
| | | | Invoice | | | | | | | | |
| | | | XY399 | | | | | | | | |
| | $2.11 | SL5 | Internet | T8 | Pay lnv0824 | 824 | Inv | 3 | 3 | TRUE | 0.2905 |
| | | | Invoice | | | | | | | | |
| | | | X824 | | | | | | | | |

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

1. A method comprising:
determining a financial data item of a financial record to be reconciled, the financial data item comprising at least one financial data string having one or more financial data characters;
determining a candidate accounting record of a plurality of accounting records;
determining an accounting data item of the candidate accounting record, the accounting data item comprising at least one accounting data string having one or more accounting data characters;
determining, as a first input to a classification model, a first similarity measure indicative of the similarity of the financial data item to the accounting data item;
determining, as a second input to the classification model, a second similarity measure indicative of the similarity of the accounting data item to the financial data item;
inputting, to the classification model, the first and second inputs, the classification model configured to determine a probability of the financial data item and the accounting data item corresponding to a common transaction; and
outputting, from the classification model, an indication of the probability of the financial data item and the accounting data item corresponding to a common transaction.

2. The method of claim 1, wherein determining the first similarity measure comprises determining a sum of the length of financial data strings of the financial data item that have at least two financial data characters present in the at least one accounting data string of the accounting data item, and wherein determining the second similarity measure comprises determining a sum of the length of accounting data strings of the accounting data item that have at least two accounting data characters present in the at least one financial data string of the financial data item.

3. The method of claim 1, wherein prior to determining a sum of the length of financial data strings of the financial record, applying a first weight to number strings of the at least one financial data string and a second weight to alphabet strings of the at least one financial data string.

4. The method of claim 1, wherein prior to determining a sum of the length of accounting data strings of the accounting record, applying a third weight to number strings of the at least one financial data string and a fourth weight to alphabet strings of the at least one financial data string.

5. The method of claim 1, further comprising:
determining, as a third input to the classification model, an absolute date difference between an accounting date associated with the accounting data item and a financial date associated with the financial data item; and
inputting, to the classification model, the third input.

6. The method of claim 1, further comprising:
determining, as a fourth input to the classification model, a due date associated with the accounting record; and
inputting, to the classification model, the fourth input.

7. The method of claim 1, further comprising:
determining, as a fifth input to the classification model, a number of common data strings between the financial data item and the accounting data item; and
inputting, to the classification model, the fifth input.

8. The method of claim 1, further comprising:
determining, as a sixth input to the classification model, a sum of the length of common data strings between the financial data item and the accounting data item; and
inputting, to the classification model, the sixth input.

9. (canceled)

10. The method of claim 1, comprising:
before determining the first and second inputs, pre-processing at least one of the financial data item and the accounting data item,
wherein pre-processing comprises:
determining one or more data strings of the financial data item or accounting data item that comprise alphanumeric words; and
for each determined alphanumeric word, modifying the financial data item or accounting data item to include a new data string for each numeral string comprising consecutive numerals of the alphanumeric word and a new data string for each alphabet string comprising consecutive letters of the alphanumeric word.

11. (canceled)

12. (canceled)

13. (canceled)

14. (canceled)

15. (canceled)

16. The method of claim 1, further comprising:
comparing the indication of the probability of the financial data item and the accounting data item of the candidate accounting record with a first threshold and a second threshold;
responsive to the indication exceeding the first threshold and the second threshold, automatically reconciling the transaction; and
responsive to the indication exceeding the first threshold but not exceeding the second threshold, presenting a suggestion for reconciling the transaction to a user via a user interface, and responsive to receiving approval from the user, reconciling the transaction.

17. (canceled)

18. A method comprising:
identifying a first feature and a second feature for reconciling transactions of a first entity by a classification model,
each transaction being associated with a financial data item of a financial record, and with an accounting data item of an accounting record,
where the first feature is a first similarity measure indicative of the similarity of the financial data item to a candidate accounting data item, and the second feature is a second similarity measure indicative of the similarity of the candidate accounting data item to the financial data item
training, by one or more processors, the classification model with training data, the training data comprising values for first and second features of an associated financial record and accounting record pair and an outcome indicative of whether the associated financial record and accounting record pair were previously matched as belonging to a common transaction; and
providing the trained classification model for reconciling transactions.

19. The method of claim 18,
wherein the financial data item comprises at least one financial data string having one or more financial data characters and the accounting data item comprises at least one accounting data string having one or more accounting data character, and
wherein the first feature comprises a number of financial data strings having at least two financial data characters present in the at least one accounting data string of the accounting data item and the second feature comprises a number of accounting data strings having at least two accounting data characters present in the at least one financial data string of the financial data item.

20. A system comprising:
one or more processors; and
memory comprising computer executable instructions, which when executed by the one or more processors, cause the system to:
determine a financial data item of a financial record to be reconciled, the financial data item comprising at least one financial data string having one or more financial data characters;
determine a candidate accounting record of a plurality of accounting records:
determine an accounting data item of the candidate accounting record, the accounting data item comprising at least one accounting data string having one or more accounting data characters;
determine, as a first input to a classification model, a first similarity measure indicative of the similarity of the financial data item to the accounting data item;
determine, as a second input to the classification model, a second similarity measure indicative of the similarity of the accounting data item to the financial data item:
input, to the classification model, the first and second inputs, the classification model configured to determine a probability of the financial data item and the accounting data item corresponding to a common transaction; and
output, from the classification model, an indication of the probability of the financial data item and the accounting data item corresponding to a common transaction.

21. A non-transitory machine-readable storage medium including instructions that, when executed by a machine, cause the machine to perform operations including:
determining a financial data item of a financial record to be reconciled, the financial data item comprising at least one financial data string having one or more financial data characters;
determining a candidate accounting record of a plurality of accounting records:
determining an accounting data item of the candidate accounting record, the accounting data item comprising at least one accounting data string having one or more accounting data characters;
determining, as a first input to a classification model, a first similarity measure indicative of the similarity of the financial data item to the accounting data item;
determining, as a second input to the classification model, a second similarity measure indicative of the similarity of the accounting data item to the financial data item;
inputting, to the classification model, the first and second inputs, the classification model configured to determine a probability of the financial data item and the accounting data item corresponding to a common transaction; and
outputting, from the classification model, an indication of the probability of the financial data item and the accounting data item corresponding to a common transaction.

22. The system of claim 13, wherein the computer executable instructions, which when executed by the one or more processors, cause the system to determine the first similarity measure by determining a sum of the length of financial data strings of the financial data item that have at least two financial data characters present in the at least one accounting data string of the accounting data item, and to determine the second similarity measure by determining a sum of the length of accounting data strings of the accounting data item that have at least two accounting data characters present in the at least one financial data string of the financial data item.

23. The system of claim 13, wherein the computer executable instructions, which when executed by the one or more processors, cause the system to apply a first weight to number strings of the at least one financial data string and a second weight to alphabet strings of the at least one financial data string, prior to determining a sum of the length of financial data strings of the financial record.

24. The system of claim 13, wherein the computer executable instructions, which when executed by the one or more processors, cause the system to applying a third weight to number strings of the at least one financial data string and a fourth weight to alphabet strings of the at least one financial data string, prior to determining a sum of the length of accounting data strings of the accounting record.

25. A system comprising:
one or more processors; and
memory comprising computer executable instructions, which when executed by the one or more processors, cause the system to:
identify a first feature and a second feature for reconciling transactions of a first entity by a classification model, each transaction being associated with a financial data item of a financial record, and with an accounting data item of an accounting record, where the first feature is a first similarity measure indicative of the similarity of the financial data item to a candidate accounting data item, and the second feature is a second similarity measure indicative of the similarity of the candidate accounting data item to the financial data item;
train the classification model with training data, the training data comprising values for first and second features of an associated financial record and accounting record pair and an outcome indicative of whether the associated financial record and accounting record pair were previously matched as belonging to a common transaction; and
provide the trained classification model for reconciling transactions.

26. The non-transitory machine-readable storage medium of claim 18, wherein
determining the first similarity measure comprises determining a sum of the length of financial data strings of the financial data item that have at least two financial data characters present in the at least one accounting data string of the accounting data item, and wherein determining the second similarity measure comprises determining a sum of the length of accounting data strings of the accounting data item that have at least two accounting data characters present in the at least one financial data string of the financial data item.

27. A non-transitory machine-readable storage medium including instructions that, when executed by a machine, cause the machine to perform operations including:
identifying a first feature and a second feature for reconciling transactions of a first entity by a classification model, each transaction being associated with a financial data item of a financial record, and with an accounting data item of an accounting record, where the first feature is a first similarity measure indicative of the similarity of the financial data item to a candidate accounting data item, and the second feature is a second similarity measure indicative of the similarity of the candidate accounting data item to the financial data item;
training the classification model with training data, the training data comprising values for first and second features of an associated financial record and accounting record pair and an outcome indicative of whether the associated financial record and accounting record pair were previously matched as belonging to a common transaction; and
providing the trained classification model for reconciling transactions.111
